(19) United States
(12) Patent Application Publication
(10) Pub. No.: US 2021/0092359 A1
(43) Pub. Date: Mar. 25, 2021

(54) METHOD, DEVICE, AND COMPUTER PROGRAM FOR CODING AND DECODING A PICTURE

(71) Applicant: CANON KABUSHIKI KAISHA, Tokyo (JP)

(72) Inventors: Eric NASSOR, THORIGNE-FOUILLARD (FR); Naël OUEDRAOGO, VAL D'ANAST (FR); Frédéric MAZE, LANGAN (FR); Gérald KERGOURLAY, CHEVAIGNE (FR)

(21) Appl. No.: 17/026,010

(22) Filed: Sep. 18, 2020

(30) Foreign Application Priority Data
Sep. 24, 2019 (GB) 1913769.4

(51) Int. Cl. H04N 19/105; H04N 19/80; H04N 19/184; H04N 19/169; H04N 19/172

(52) U.S. Cl. CPC H04N 19/105; H04N 19/80; H04N 19/172; H04N 19/188; H04N 19/184

(57) ABSTRACT

A method for encoding video data into a bitstream of logical units, said video data comprising pictures, comprises:
encoding into the bitstream a first picture belonging to a first layer in the form of a first set of logical units;
encoding into the bitstream a second picture belonging to a second layer different from the first layer, at least a part of the second picture being configured to display at least a first part of the first picture, the encoding of the second picture comprising encoding a first reference between the at least first part of the first picture and at least one logical unit of the first set of logical units.

### CROSS REFERENCE TO RELATED APPLICATION

This application claims the benefit under 35 U.S.C. § 119(a)-(d) of United Kingdom Patent Application No. 1913769.4, filed on Sep. 24, 2019 and entitled “Method, device, and computer program for coding and decoding a picture”. The above cited patent application is incorporated herein by reference in its entirety.

### FIELD OF THE INVENTION

The present invention relates to a method, a device, and a computer program for encoding and decoding pictures.

### BACKGROUND OF THE INVENTION

To encode an image, a technique often used is to partition it into picture portions which are then encoded independently of each other. The whole is then grouped together to form the encoded image. The decoding of the image is then carried out in the opposite direction by decoding the encoded picture portions and then assembling the result of the decoding to reconstitute the initial image.

The compression of video relying on block-based video encoding is used in most coding systems like HEVC (High Efficiency Video Coding), or the emerging VVC (Versatile Video Coding) standards.

In these encoding systems, a video is composed of a sequence of frames or pictures or images or samples which may be displayed at several different times. In the case of multilayer video (for example scaleable, stereo, 3D videos), several pictures may be decoded to compose the resulting image to display at one instant, the pictures belonging to different layers. A picture can also be composed of different image components. For instance, for encoding the luminance, the chrominance or depth information.

The result of the encoding process is a bitstream defined as a sequence of bits, that forms the representation of coded pictures and associated data forming one or more coded video sequences (CVSs). The sequence of bits is organized in the form of a stream of “network abstraction layer (NAL) units.” NALUs, which are syntax structures containing an indication of the type of data to follow and bytes containing that data.

Typically, these encoding systems rely on several partitioning techniques for each picture. VVC has introduced a partitioning concept called subpicture. A subpicture is defined as a rectangular region of one or more slices within a picture. A slice is an integer number of bricks of a picture that are exclusively contained into a single NALU. Consequently, in a multilayer video, a subpicture belongs to a picture which belongs to a layer.

### SUMMARY OF THE INVENTION

However, the subpictures may also be useful in a scenario where a picture may use information from a layer different from the layer of the picture. For instance, it may be useful to reduce the bitstream size by avoiding copying identical data belonging to different layers.

The present invention has been devised to address one or more of the foregoing concerns.

In a first example embodiment, a method for encoding video data into a bitstream of logical units, the video data comprising pictures, comprises:

encoding into the bitstream a first picture belonging to a first layer in the form of a first set of logical units;

encoding into the bitstream a second picture belonging to a second layer different from the first layer, at least a part of the second picture being configured to display at least a first part of the first picture, the encoding of the second picture comprising encoding a first reference between the at least first part of the first picture and at least one logical unit of the first set of logical units.

Accordingly, the method advantageously authorises a picture to be defined partly by reference to data from another layer, avoiding to copy the same picture elements in all layers.

This embodiment may comprise other features, alone or in combination, such as
the method further comprises encoding into the bitstream a third picture in the form of a second set of logical units, the third picture belonging to a third layer different from the second layer, and the encoding of the second picture further comprises encoding a second reference between a second part of the second picture and at least one logical unit of the second set of logical units;
the method further comprises encoding into the bitstream information associated with the second layer, the information comprising a list of the layers containing logical units referenced by the parts of the second picture;
the method further comprises encoding information associated to each layer indicating if each layer comprises or not at least one picture having a part referencing logical units of another layer;
the encoded pictures are further grouped into access units, one access unit grouping pictures with a same timing, and wherein the first picture and the second picture belong to the same access unit or to two correlated access units;
the encoding of the second picture further comprises encoding a second part of the second picture in the form of logical units belonging to the second layer, the second part being different from the first part;
encoding the first reference comprises:
encoding a first sub-reference between the first part and a slice address,
encoding a second sub-reference between the slice address and the at least one logical unit of the first set of logical units.

Among the advantages of these features, elements may be referenced from any layer, without limitation on the layer number; the layers referenced by the second layer being known as soon as the layer header is read, the decoder may limit its analysis to these layers; a picture may be a combination of “classically” coded elements and of referenced elements.

According to a second aspect of the invention, there is provided a method for merging at least two bitstreams of logical units of video data, comprising:

assigning at least one merged layer to the logical units of each bitstream;

defining a merging layer;

encoding a merging picture belonging to the merging layer, the merging picture comprising at least, per merged layer, a part of a picture and an associated reference between the part of the picture and logical units of the merged layer;

merging into one encoded bitstream the merging picture and the logical units of the merged bitstream.

According to a third aspect of the invention, there is provided method for decoding video data from a bitstream of logical units, the video data comprising pictures, the method comprising:

detecting that a first picture of a first layer comprises a part of the first picture, the part of the first picture comprising a reference to logical units of a second picture belonging to a second layer;

selecting the referenced logical units;

decoding the referenced logical units to obtain the part of the first picture;

into the decoded first picture.

This embodiment may comprise other features, such as the method here above comprises beforehand:
analysing a header associated with the first layer;
detecting that the first layer uses logical units from at least a second layer,
filtering logical units to keep logical units associated with the first layer and the at least second layer.

According to a fourth aspect of the invention, there is provided a computer program product for a programmable apparatus, the computer program product comprises a sequence of instructions for implementing each of the steps of the methods here above when loaded into and executed by the programmable apparatus.

According to a fifth aspect of the invention, there is provided a non-transitory computer-readable storage medium storing instructions of a computer program for implementing each of the steps of the methods described above.

According to a sixth aspect of the invention, there is provided a device comprising a processing unit configured for carrying out some or all of the steps of the methods described above.

According to a seventh aspect of the invention, there is provided a signal carrying encoded video data as a bitstream of logical units, the video data comprising pictures, as resulting from the method described above.

According to an eighth aspect of the invention, there is provided a media storage device storing a signal carrying encoded video data as a bitstream of logical units, the video data comprising pictures, as resulting from the method described above.

The second, third, fourth, fifth, sixth, seventh and eighth aspects of the present invention have advantages similar to the first above-mentioned aspect.

At least parts of the methods according to the invention may be computer implemented. Accordingly, the present invention may take the form of an entire hardware embodiment, an entire software embodiment (including firmware, resident software, microcode) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer-readable code for provision to a programmable apparatus on any suitable carrier medium. A tangible carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g., a microwave or RF signal.

### BRIEF DESCRIPTION OF THE DRAWINGS

The embodiments of the invention will now be described, by way of example only, and with reference to the following drawings in which:

FIG. 1 illustrates an access unit;

FIG. 2 illustrates an image structure with subpictures;

FIG. 3 illustrates region scaleability by using subpictures of another layer;

FIG. 4 illustrates a bitstream merging;

FIG. 5 illustrates the main processing steps of an encoder;

FIG. 6 illustrates the main processing steps of a decoder;

FIG. 7 illustrates a bitstream as a result of the encoding process of FIG. 5;

FIG. 8 illustrates a variant of region scaleability; and,

FIG. 9 illustrates a schematic block diagram of a computing device.

### DETAILED DESCRIPTION OF THE INVENTION

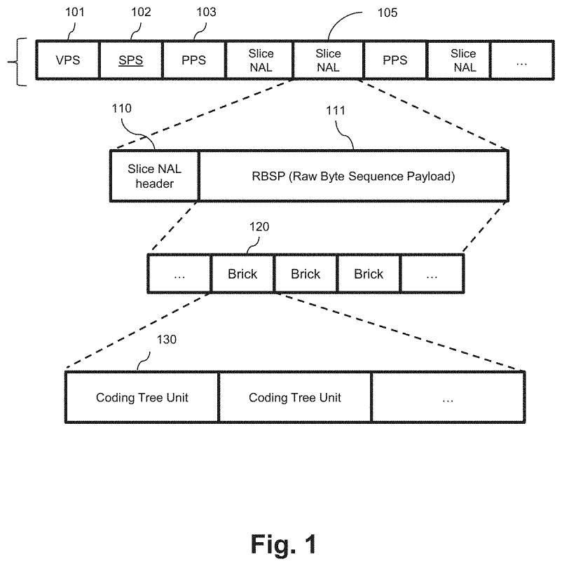

FIG. 1 illustrates a bitstream structure and particularly an access unit.

Images with the same timing (from one or several layers) are generated in the bitstream in the same Access Unit. It could also be possible to generate encoded pictures from different independent layers but at same timing in several correlated access units. The correlated access units may have different Picture Order Count (POC) but the same timing information. This may allow decoding several independent layers with only one decoder.

The bitstream for an Access Unit is then composed of NAL units which can be parsed independently. The NAL units may contain parameter set(s) (Video Parameter Set VPS 101, Sequence Parameter Set SPS 102, Picture Parameter Set PPS 103) or slices 105. A NALU has a header 110 describing its content and an end marker allowing the decoder to resynchronize in case of a bitstream error. The decoder parses the NAL unit syntax and then decodes its content. In case of a slice NALU, the payload contains data of the picture elements composing the slice (bricks and coding tree units).

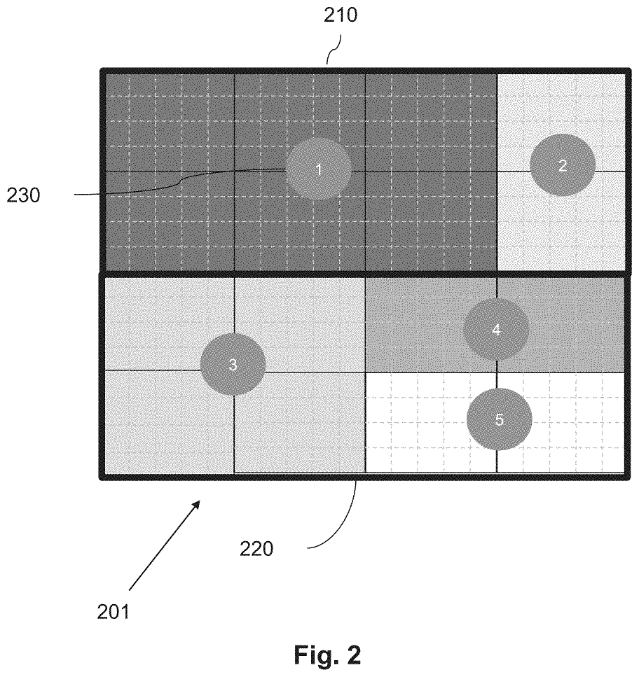

FIG. 2 illustrates an image structure.

The picture 201 is composed of 2 sub-pictures 210 and 220 with the wide black border. The picture pixels are also partitioned in slices (for example 230). The subpicture corresponds to a group of one or several slices (the subpicture 210 is composed of the slices 1 and 2). The border of a subpicture corresponds to the border of slices. The slices are groups of bricks or tiles. A brick and a tile are sub portions of an image but with different spatial forms. Here, the picture is composed of a grid of 4 by 4 tiles.

Each brick (or tile) has its own entropy coding context, so the brick stops the entropy coding dependencies. Depending on options, the brick may also stop the spatial dependencies: pixels from one brick are not predicted from another brick. The group of bricks encoded in a slice generates a NALU. So a NALU can be decoded with no reference to another NALU in the same image. Depending on options, subpictures can be encoded independently: pixels from a subpicture are coded with no reference to other subpictures from the same picture or from previous images.

In the following embodiments, a subpicture may also be a group of slices coded with no reference to another subpicture and no constraints on the form of the region (could be non-rectangular or even composed of several disjoined regions).

Subpictures may be used for example for bitstream merging: to generate a new bitstream easily from the merging of several bitstreams without needing to decode and encode again the bitstreams. Subpictures may also be used for example for viewport-dependent streaming to easily change the position of the subpictures in the image without needing to decode and encode again the bitstream.

The problem addressed here is how to reuse a subpicture from one layer in another layer without duplication of the encoded data describing the subpicture. The following embodiments have the advantage to propose a way to support view scaleability, viewport dependent omnidirectional video as well as bitstream merging.

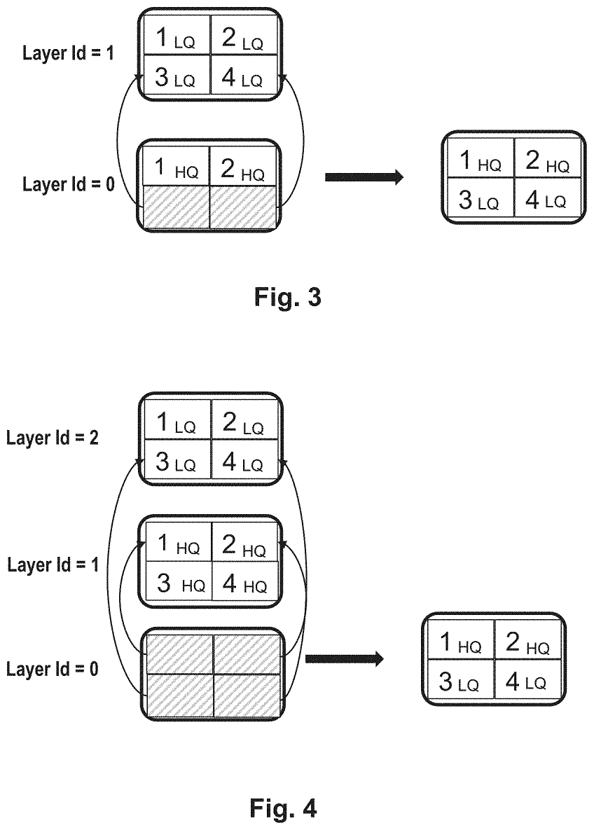

FIG. 3 illustrates an example of region scaleability. The layer with LayerId=1 defines 4 subpictures with a low quality. The layer with LayerId=0 provides a higher quality for 2 subpictures and reuses the 3rd and 4th subpictures of lower quality from layer 1. When decoded, the layer 0 would thus provide an image with regions of higher quality.

FIG. 4 illustrates a merge operation between two independent layers with layer_id respectively equal to 1 and 2. A 3rd layer is added with a layer_id equal to 0. This merging layer 0 references subpictures from the other layers: slices from the layers 1 and 2 are reused to compose the new image for layer 0. This allows a simple merge process between different bitstreams.

To support these different operations, in the following embodiments, a reference is included in the bitstream. The reference belongs to a layer and points to a slice of a picture belonging to another layer.

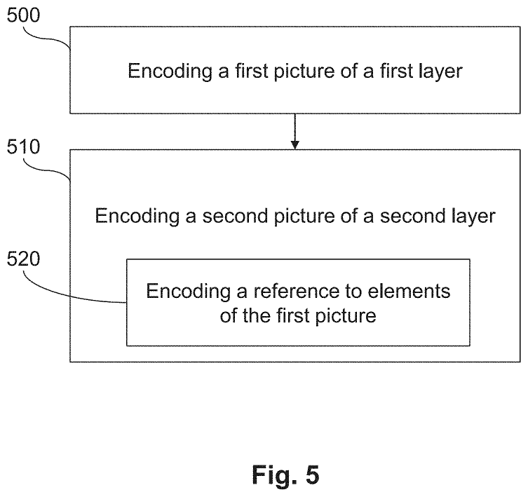

In its broadest acceptation, FIG. 5, a method for encoding video data into a bitstream of logical units, said video data comprising pictures, comprises:
Encoding, step 500, into the bitstream a first picture belonging to a first layer in the form of a first set of logical units;
Encoding, step 510, into the bitstream a second picture belonging to a second layer different from the first layer, said encoded second picture comprising a first subpicture, the encoding of the second picture comprising encoding, step 520, a first reference between the first subpicture and at least one logical unit of the first set of logical units.

The method is particularly suitable for the VVC standard and the following detailed embodiments are based on this standard. However, the method may be transposed to other similar video methods which encode video data into a structured bitstream.

Inside the VVC standard, the following elements may be defined:
1. A Multi-Layer SubPictures (MLSP) layer, which may be called reference layer, that allows building decoded pictures by referencing and directly integrating the subpictures, or slices, from other layers, also called referenced layers.
2. A signalling syntax elements in the bitstream describing the new dependency relationship between Multi-Layer SubPictures layer and its referenced layers. The “reference” dependency may be provided in the Video Parameter Set (VPS).
3. A signalling syntax element in the bitstream describing the mapping from subpictures of the Multi-Layer SubPictures layer to pictures from referenced layers. This description may be located inside the Picture Parameter Set (PPS) or the Sequence Parameter Set (SPS). This syntax element may be considered as the reference of the method of FIG. 5 for the VVC standard.
4. A specific VCL NALU with no coded data: its goal is to indicate the modified decoding parameters for the VCL NAL units from the referenced layers.
5. A decoding process that allows reusing encoded NALUs from one layer in another layer.

Consequently, by using these elements, the method of FIG. 5 may be written as: in a bitstream of NALUs, encoding a first picture belonging to a referenced layer in the form of a first set of NALUs, comprising slice NALUs, encoding a second picture belonging to a referencing layer, the second picture having a subpicture, a signalling syntax element describing/referencing the mapping from the subpicture of the second image of the second/Multi-Layer SubPictures layer to slices from referenced layers.

These elements are thus centred around a special layer, the MLSP layer, with its associated signalling elements indicating which slices from other layers are reused by the MLSP layer.

Now, different detailed embodiments with variants will be disclosed based on the current VCC specification.

In the specification, at elementary bitstream, it is possible to define independent layers which means layers that are coded completely independently in the bitstream. Inside these layers, independently coded regions, the subpictures may be defined.

In the disclosed embodiment, a new type of layer is defined: A Multi-Layer SubPictures layer, or MLSP layer.

An MLSP layer is an independent layer allowing cross-layer subpicture decoding, from slices from other independent layers. This MLSP layer references the coded data (VCL NAL units) from at least one other layer. Let's denote the MLSP layer as “reference layer” and the layers from which the slices are referenced as “referenced layers.”

The current VCC specification does not define such a reference layer. In the specification, a layer and a layer access unit are defined as follows: “( . . . )
A layer is a set of VCL NAL units that all have a particular value of nuh_layer_id and the associated non-VCL NAL units.
A layer access unit is a set of NAL units for which the VCL NAL units all have a particular value of nuh_layer_id, that are associated with each other according to a specified classification rule, that are consecutive in decoding order, and that contain exactly one coded picture.

( . . . )”

The reference, or MLSP, layer is defined by:
Multi-layer subpictures (MLSP) layer access unit: A layer access unit in which the coded picture is an MLSP picture.
Multi-layer subpictures (MLSP) picture: A coded picture for which the first VCL NAL unit has nal_unit_type equal to MLSP_NUT and for which the decoding process may directly decode VCL NAL units from a slice, of other coded pictures within the same access unit.

In other words, an MLSP layer may contain MLSP pictures and an MLSP picture is defined by having one NAL unit of a new type MLSP NUT. Its decoding will use NAL units from the pictures of the referenced layers. In embodiment 1, the layer id of the referenced layers is higher than the layer id of the reference layer. This allows to keep the current constraint on the order of the NAL units in the bitstream which is described in VVC specification, but other embodiments release this constraint.

An MLSP picture may also contain subpictures defined in the MLSP picture and not copied from another layer. In the example of FIG. 3, the layer0 contains the NAL units for subpictures 1 and 2 at high quality and references subpictures 3 and 4 from layer 1. In a more formal way, an MLSP picture may include zero or more VCL NAL units having a different nal_unit_type.

The MLSP layer decoding process will use VCL NAL units that can have different values of nuh_layer_id corresponding to the nuh_layer_id values of the referenced layer(s) and the associated non-VCL NAL units.

It can be useful to have in the bitstream an indication of the reference dependencies between the reference layer and the referenced layers. This indication allows a simpler decoding process.

A new kind of dependency is introduced: a “reference dependency”. The “reference” dependency is provided in the VPS to indicate for each MLSP layer, the list of layers it references.

The VPS syntax includes new syntax elements to specify that the coded video sequence may include such kind of new inter layer subpicture referencing.

TABLE 1 discloses the new VPS syntax.

Three embodiments for the new VPS syntax are discussed under reference Embodiment 1, Embodiment 2 and Embodiment 3.

### Embodiment 1

vps_multi_layer_subpicture_flag[i] equal to 1 specifies that the layer with index i may reference slices from another layer and indicates the presence of vps_subpicture_reference_layerIdx_minus1_flag [i]. vps_multi_layer_subpicture_flag[i] equal to 0 specifies that the layer with index i does not reference slices from another layer and indicates the absence of vps_subpicture_reference_layerIdx_minus1_flag [i].

vps_subpicture_reference_layerIdx_minus1_flag[i][j] equal to 0 specifies that the subpicture from the layer with index i does not reference slices of the layer with index j+1. vps_subpicture_reference_layerIdx_minus1_flag[i][j] equal to 1 specifies that the subpicture from the layer with index i may reference slices of the layer with index j+1. When vps_subpicture_reference_layerIdx_minus1_flag [i][j] is not present for i in the range of 0 to vps_max_layers_minus1−1 and j in the range of 0 to vps_max_layers_minus1, inclusive, it is inferred to be equal to 0.

In Embodiment 1, the MLSP layer has a layer id lower than the layer id of the referenced layers. Thus the value vps_subpicture_reference_layerIdx_minus1_flag[i][j] is equal to 0 when j is lower than i.

The variable SubPicReferencedLayerIdx[i][j], specifying the j-th layer referenced by subpictures of the i-th layer, is derived as follows:

```
for( i = 0; i < vps_max_layers_minus1 − 1; i++ )
  if( vps_multi_layer_subpicture_flag[ i ] )
    for( j = i, k = 0; j < vps_max_layers_minus1; j++ ) (7 3)
      if( vps_subpicture_reference_layerIdx_minus1_flag[ i ][ j ] )
        SubPicReferencedLayerIdx[ i ][ k++ ] = j + 1
```

### Embodiment 2

In the Embodiment 2, the MLSP layer has a layer id higher than the layer id of the referenced layers.

vps_multi_layer_subpicture_flag[i] equal to 1 specifies that the layer with index i may reference slices from another layer and indicates the presence of vps_subpicture_reference_flag[i]. vps_multi_layer_subpicture_flag[i] equal to 0 specifies that the layer with index i does not reference slices from another layer and indicates the absence of vps_subpicture_reference_flag [i].

vps_subpicture_reference_flag[i][j] equal to 0 specifies that the subpicture from the layer with index i does not reference slices of the layer with index j. vps_subpicture_reference_flag [i][j] equal to 1 specifies that the subpicture from the layer with index i may reference slices of the layer with index j. When vps_subpicture_reference_flag[i][j] is not present for i and j in the range of 0 to vps_max_layers_minus1, inclusive, it is inferred to be equal to 0.

The new syntax elements are similar to the previous embodiment but in this case the value vps_subpicture_reference_flag[i][j] is equal to 0 when j is higher than i.

The variable SubPicReferencedLayerIdx[i][j], specifying the j-th layer referenced by subpictures of the i-th layer, is derived as follows:

```
for( i = 1; i < vps_max_layers_minus1; i− − )
  if( vps_multi_layer_subpicture_flag[ i ] )
    for( j = i, k = 0; j >= 0; j− − ) (7 2)
      if( vps_subpicture_reference_flag[ i ][ j ] )
        SubPicReferencedLayerIdx[ i ][ k++ ] = j
```

In Embodiment 3, the layer reference dependencies are not explicitly described in the VPS. In this case, when there is a dependency between an MLSP layer i and a referenced layer j, the existing syntax element vps_direct_dependency_flag[i][j] should be set to 1. In this case the MLSP layer can only reference layers with a lower layer id. It is then not possible to infer the reference dependencies from the VPS. These dependencies will be computed from the subpicture utilisation declaration.

Another syntax element indicates for each subpicture inside an MLSP picture, if a slice from a referenced layer should be used and identifying the layer containing the slices to use.

In this embodiment the syntax indicates the layers from which the slices should be used. There is no indication of subpictures in the referenced layers so that the referenced layers may have different subpicture partitioning or even no subpictures. Only the slice ids should be identical between the description of the slices in the PPS of the MLSP layer and the slice addresses indicated in the slice header.

A flag in the Sequence Parameter Set is added, TABLE 2.

subpics_multi_layer_flag equal to 1 indicates that subpictures of coded pictures referring to the SPS may reference coded slices from another coded pictures with a different nuh_layer_id within the same access unit and indicates the presence of subpic_layer_id_flag[i]. subpics_multi_layer_flag equal to 0 indicates that subpictures of coded pictures referring to the SPS does not reference coded slices from another coded pictures with a different nuh_layer_id within the same access unit and indicates the absence of subpic_layer_id_flag[i]. When sps_video_parameter_set_id is equal to 0, the value of subpics_multi_layer_flag is inferred to be equal to 0.

The subpicture dependency may be implemented with different embodiments. Two of them, called Embodiment 4 and Embodiment 5, are discussed.

In Embodiment 4, the subpicture dependency may be included in the Picture Parameter Set.

The new syntax elements indicate whether the slices of a subpicture reference slices of another layer. When one subpicture references another layer, the syntax specifies the identifier of the referenced layer. This information is sufficient for the new decoding process described in the following section, TABLE 3.

subpic_layer_id_flag[i] equal to 1 indicates the presence of subpic_layer_id[i] and that the i-th subpicture of each coded picture in CVS references coded slices with nuh_layer_id equal to subpic_layer_id[i]. subpic_layer_id_flag[i] equal to 0 indicates the absence of subpic_layer_id[i] and that the i-th subpicture of each coded picture in CVS does not reference coded slices from coded pictures with a different nuh_layer_id.

subpic_layer_id[i] when present specifies the nuh_layer_id of the coded slices referenced by the i-th subpicture. When not present, subpic_layer_id[i] is inferred equal to the nuh_layer_id of the current PPS parameter set NAL unit.

With these syntax elements, it is possible for a decoder to determine the VCL NAL units of each subpicture as follows.

The decoder determines the subpicture index i for each slice defined in the PPS. When the subpicture i has subpic_layer_id_flag[i] equal to 0, the decoder decodes the slice with slice_address as defined in PPS and with a nuh_layer_id equal to the identifier of the current layer. Otherwise, if subpic_layer_id_flag[i] is equal to 1, the decoder decodes the slice with slice_address as defined in PPS and with a nuh_layer_id equal to the value subpic_layer_id[i], so the decoder decodes the selected slices of the referenced layer subpic_layer_id[i] to obtain the subpicture i of the MLSP layer.

Embodiment 4 has the following advantage: the subpicture pattern may not change very often (stable SPS) but the mapping may change at each picture (new PPS at each picture). This can be useful for example in the context of OMAF (omnidirectional video: the direction of the viewer can change rapidly and thus the mapping of the subpictures quality can change at each image).

In Embodiment 5, the same information is included into the SPS, TABLE 4.

subpic_layer_id_flag[i] equal to 1 indicates the presence of subpic_layer_id[i] and that the i-th subpicture of each coded picture in CVS references coded slices with nuh_layer_id equal to subpic_layer_id[i]. subpic_layer_id_flag[i] equal to 0 indicates the absence of subpic_layer_id[i] and that the i-th subpicture of each coded picture in CVS does not reference coded slices from coded pictures with a different nuh_layer_id.

subpic_layer_id[i] when present specifies the nuh_layer_id of the coded slices referenced by the i-th subpicture. When not present, subpic_layer_id[i] is inferred equal to the nuh_layer_id of the current SPS parameter set NAL unit.

With the proposed syntax elements, it is possible for a decoder to determine the VCL NAL units of each subpicture as follows.

The decoder determines the subpicture index i for each slice defined in the PPS. When the subpicture i has subpic_layer_id_flag[i] equal to 0 in the associated SPS, the decoder decodes the slice with slice_address as defined in PPS and with a nuh_layer_id equal to the identifier of the current layer. Otherwise, if subpic_layer_id_flag[i] equal to 1 in the associated SPS, the decoder decodes the slice with slice_address as defined in PPS and with a nuh_layer_id equal to the value subpic_layer_id[i], so the decoder decodes the selected slices of the referenced layer subpic_layer_id[i] to obtain the subpicture i of the MLSP layer.

This syntax has the advantage to group the definition of the subpictures and their mapping between layers in one same place. This simplifies the decoder.

Remark in the case of the Embodiment 3. where no explicit dependency is described in the VPS, it is possible to deduce the reference dependency between layers from the values of subpic_layer_id[i]. If the PPS from one layer j contains a description of subpicture i with the value subpic_layer_id[i] indicating a layer k, this means that the MLSP layer j is referring the layer k and thus there is a reference dependency from j to k.

The bitstream of the encoded video is composed of NAL units. Each NAL unit contains a header and then an RBSP payload (Raw Byte Sequence Payload). The header contains the layer id and the NAL unit type. The payload content depends of the NAL unit type.

A new type of NAL unit MLSP_NUT is added in order to allow the decoding of MLSP layer. This new NAL unit should be the first NAL unit of an access unit in an MLSP layer.

The list of NALU types is updated as in TABLE 5.

The payload of the new MLSP_NUT NAL unit has thus the same definition as slice NAL units.

The syntax of the slice layer RBSP syntax is disclosed TABLE 6.

The goal of such VCL NALU is to overload the “PPS in use” (according to the decoding process) when a VCL NALU is used by reference from a reference layer. Thus, all the slice data content may be skipped.

Another embodiment would be to change the slice payload to indicate only the new PPS id as described in TABLE 7.

In these two embodiments, all VCL NAL units associated with an MLSP picture (except the first VCL NAL unit with nal_unit_type equal to MLSP_NUT) either directly part of the MLSP picture (i.e., having same nuh_layer_id as MLSP picture nuh_layer_id) or referenced by an MLSP picture (i.e., having a different nuh_layer_id) may have nal_unit_type consistent with the definition of one of the other types of picture (CRA, GDR, IDR, RADL, RASL, STSA).

For decoding process purpose, the MLSP picture may be considered as being a CRA or GDR or IDR or RADL or RASL or STSA picture according to the nal_unit_type of its associated VCL NAL units.

Another embodiment would be to have no new NAL unit type. In this case another method must be used to determine the PPS id used by the MLSP layer. A solution can be to define the PPS in use by the MLSP layer as equal to the PPS in use from another layer in the same access unit.

This solution has the advantage to simplify the syntax by avoiding a new NAL unit type but it imposes to have in the bitstream at least one NAL unit from another layer before any NAL unit from the MLSP layer and from any referenced layer.

In a variant, a new flag IsMLSPSlice is added inside the slice header or inside the slice data indicating that the slice is a MLSP slice. If the value of the flag is 1, all the remaining slice data can be skipped. The MLSP slice should be the first NAL unit of an access unit in an MLSP layer. The goal of the MLSP slice is to change the “PPS in use” similarly as the MLSP_NUT NAL unit of the previous embodiment.

This solution has the advantage to simplify the syntax by avoiding a new NAL unit type and it does not impose to have in the bitstream at least one NAL unit from another layer before any NAL unit from the MLSP layer and from any referenced layer

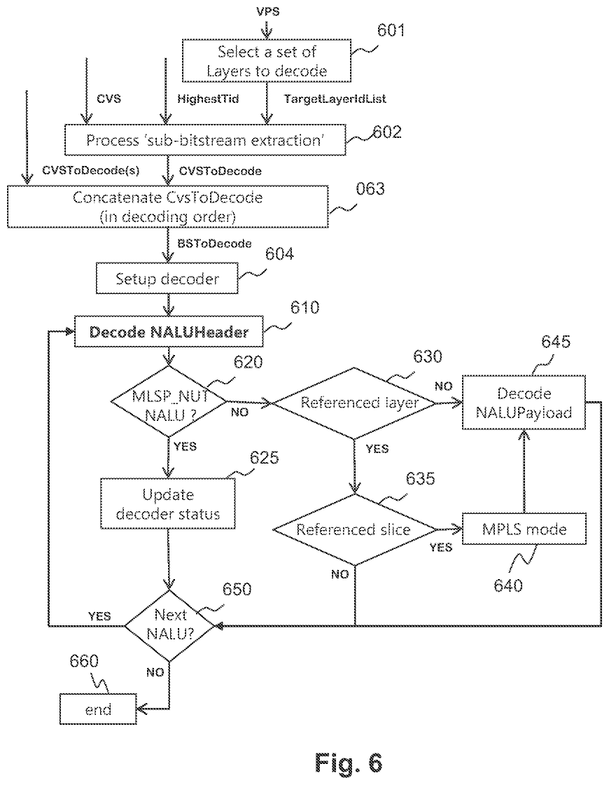

In order to handle the cross-layer decoding, a number of modifications in the decoding process are required. The flow chart of FIG. 6 shows the process of slice data decoding from a video bitstream, composed of an MLSP layer and different subpictures from one or several referenced layers.

The main steps are described below.

Step 601: Select a set of layers to decode

The output of this step is a list of target layers: TargetLayerIdList.

Ideally if the target layer is an MLSP layer, only the MLSP layer and the referenced layer should be kept. This can be initialised by some external means: a command line parameter to the decoder, or the initialisation of the decoder in a streaming client. This process can also be initialised from the list of reference dependencies indicated in the VPS.

Otherwise all the layers are included in the list of target layers.

Step 602: Process “sub-bitstream extraction.”

For each CVS (Coded Video Stream) in the bitstream, the sub-bitstream extraction process is applied with the CVS, TargetLayerdList, and HighestTid—which identifies the highest temporal sub-layer to be decoded—as inputs, and the output is assigned to a bitstream referred to as CvsToDecode. This step allows keeping only the bitstream corresponding to the layers to decode.

Step 603: Concatenate CvsToDecode (in decoding order)

The instances of CvsToDecode of all the CVSs are concatenated, in decoding order, and the result is assigned to the bitstream BSToDecode. This step allows concatenating several bitstream to decode.

It is assumed in the following steps that the bitstream to decode contains only one MLSP layer to decode and at least all the referenced layers.

Step 604: Setup decoder

The decoder is then initialised and start to read all the NALU from the bitstream BSToDecode.

Step 610: Decode NALUHeader:

Inputs to this process are the NAL units of the current bitstream BSToDecode and their associated non-VCL NAL units.

The decoding process for each NAL unit extracts the NAL unit type, the layer id (nuh_layer_id) the RBSP syntax structure from the NAL unit and then parses the RBSP syntax structure.

The variable isMLSPPic is set equal to 0 to indicate that the decoder is in normal state (not for MLSP subpicture).

Step 620: MLSP_NUT NALU?

This step checks if the current NALU if of type MLSP_NUT. If Yes, it goes to step 625: Update decoder status, if No, goes to step 630.

Step 625: update decoder status

The variable isMLSPPic is set equal to 1 to indicate that the decoder is decoding an MLSP picture.

The decoder memorises the current layer id and PPS id:
The variable MLSPNaluLayerId is set equal to nuh_layer_id of VCL NAL unit.
The variable MlspPpsIdInUse is set equal to slice_pic_parameter_set_id of VCL NAL unit.

Based on the value MlspPpsIdInUse the decoder can obtain the table of the imported subpicture layers (subpic_layer_id[i]) which can be in the PPS or the SPS referenced by the PPS.

Step 630: referenced layer test

This step tests if the NALU is a VCL NAL unit with nuh_layer_id not equal to MLSPNaluLayerd: is it a slice (video coding layer) which is not in the MLSP layer?

In case the response is no (the NALU is part of the MLSP layer, for example for parameter sets, or the slice defined in the MLSP layer) the decoder will decode the NAL unit in a normal way (step 645). Otherwise (the NAL unit is part of a referenced layer) it goes to step 635.

Step 635: Referenced by MLSP layer?

This step checks if the current slice NAL unit is referenced by the MLSP layer.

The variable isReferencedByMLSPPicture is derived as follows:

isReferencedByMLSPPicture=0;

SubPicIdx=CtbToSubPicIdx[CtbAddrBsToRs[FirstCtbAddrBs[SliceBrickIdx[0]]]]
If (nuh_layer_id==subpic_layer_id[SubPicIdx])
   isReferencedByMLSPPicture=1

The decoder determines what the subpicture id of the slice is. To obtain the subpicture id of the slice, the decoder must read the slide address which is indicated in the slice header. The slice address is then used with the brick decomposition described in the PPS from the MLSP layer (and not the initial value of slice_pic_parameter_set_id in the slice header: the decoder is not using the PPS of the referenced layer). If the slice address is not present in the PPS, the slice is not used (isReferencedByMLSPPicture=0).

If the slice address is present in the PPS, the decoder obtains the index of the first brick in the slice (SliceBrickIdx[0]). The address of the brick is transformed in a CTB index with the table FirstCtbAddrBs. The index of the CTB is transformed from brick scan order to raster scan order by using the table CtbAddrBsToRs. The CTB index is then converted to a subpicture index using the table CtbToSubPicIdx which is computed from the subpicture positions in the SPS of the MLSP layer.

In another embodiment, the association between the slice addresses and the subpicture index could be described explicitly for example in the PPS. In this case the decoder could use this table from the PPS of the MLSP layer to obtain the subpicture index associated with the slice address of the NAL unit in the MLSP layer.

Then the decoder uses this subpicture id with the table of the imported subpicture layers from the MLSP layer (memorised in step 625). The decoder verifies that the subpicture id is imported from the layer nuh_layer_id indicated in the NAL unit header to determine if the NAL unit should be decoded to obtain the content of the subpicture.

If the slice is referenced by the MLSP picture, the process goes to Step 640 (VCL NAL units for which isReferencedByMLSPPicture is equal to 1 are decoded in the context of the MLSP picture).

If No. the decoder goes to Step 650: Next NALU? (VCL NAL units for which isReferencedByMLSPPicture is equal to 0 are skipped).

Step 640: MLSP Mode

VCL NAL units referenced by the MLSP layer should be decoded with nuh_layer_id equal to MLSPNaluLayerId and the PPS in use is MlspPpsIdInUse. In order to do this the variable isMLSPPic is set equal to 1 to indicate that the decoder is decoding an MLSP picture and the nuh_layer_id value is set to MLSPNaluLayerId.

Step 645: Decode NALUPayload

This is the normal decoding process of a NAL unit except that the step is modified when the slice picture parameter set id is read in the following way:

slice_pic_parameter_set_id specifies the value of pps_pic_parameter_set_id for the PPS in use. The value of slice_pic_parameter_set_id shall be in the range of 0 to 63, inclusive. When the variable isMLSPPic is equal to 1, slice_pic__parameter_set_id is ignored and the value of pps_pic_parameter_set_id for the PPS in use is set to MspPpsIdInUse.

Step 650: Next NALU?

This step checks if the current NALU is followed by a next one. If Yes, it goes to step 610: Decode NALUPayload, if No, goes to step 660: end

step 660: end.

The decoder has completed the decoding.

The decoder reads and decodes the bitstream sequentially. It is impossible for the decoder to go back in the bitstream to read again a previous part of the bitstream. It is also impossible for the decoder to change the bitstream. These constraints have been considered in the disclosed syntax elements and decoding process. This is very different from the operations which can be done in the system encapsulation and file format.

In current VVC specification, there is a constraint on the order of the layers from an access unit in the bitstream: an access unit consists of an access unit delimiter NAL unit and one or more layer access units in increasing order of nuh_layer_id. In disclosed embodiments this constraint has been kept in order to be more compatible with existing decoder architecture.

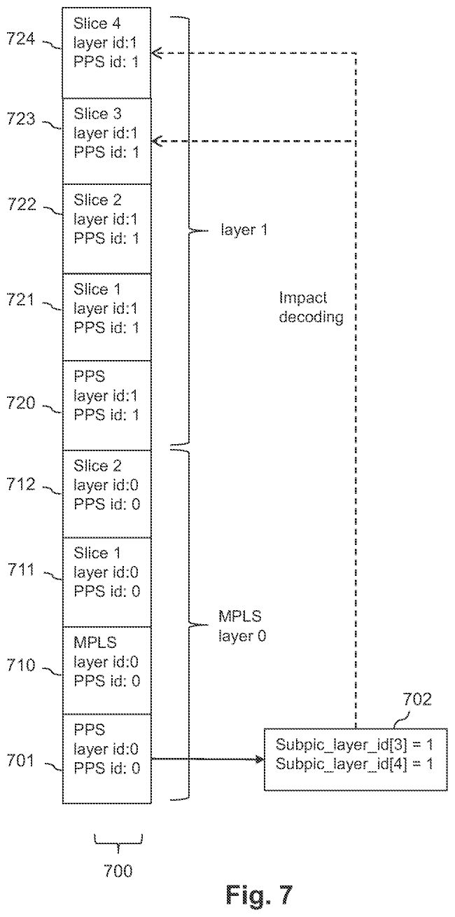

An example of bitstream is represented on FIG. 7. The figure represents a possible bitstream 700 for one Access Unit corresponding to the MLSP example presented in FIG. 3. In this example it is assumed, there is only 1 slice per subpicture. The access unit bitstream is composed of 4 NAL units for layer 0 and then 5 NAL units for layer 1. The layer 0 contains the Picture Parameter Set unit 701 with a pps-id of value 0, the MLSP NAL Unit 710 indicating that the PPS for the MLSP layer 0 is the PPS 0. The PPS 0 also contains the subpicture mapping 702 which indicates that the subpictures 3 and 4 should be read from the layer 1.

Then the coded data for subpictures 1 and 2 in layer 0 at high quality is given is NAL units 711 and 712. The layer 1 is then coded with Picture Parameter Set of value pps_id 1 and 4 NAL units giving the content of the 4 subpictures at low quality.

When decoding the MLSP layer following the algorithm from the previous section, the decoder will read the MLSP NAL unit and update the decoder status by memorising the layer_id and pps_id. The normal decoding process is applied to slice 1 and 2 from layer 0. Then the slices 1 and 2 from layer 1 are skipped and finally the slices 3 and 4 from layer 1 are decoded in the context of the MLSP layer: the layer_id and the PPS id from the slice are ignored and instead the layer_id used is 0 and the pps_id used is 0.

For merging two bitstream and add an MLSP layer representing the merged video (as in the example of FIG. 4), it is necessary to add an MLSP layer of lower value (layer 0 in the example). It is thus useful to keep some low values of layers not used during the encoding of an independent video if we want to simplify the merge operation.

It could be useful to release the constraint on the order of the layers in the access unit bitstream. This would provide several advantages: this is necessary to describe the layer dependencies in another way as in embodiments 2 and 3.

But it is also useful even with the layer dependencies described in other embodiments. Indeed, a relaxed layer constraint is useful to simplify the operation of merging of bitstream: it is easier to add a new layer representing the merge of two different bitstreams even if all low values of layer id have been used.

But even if it is authorised to mixed NAL units from different layers, the MLSP NAL unit is positioned in the bitstream before any NAL unit from the referenced layers in order that the decoder be able to apply the updated decoding process when reading the slice from the referenced layer.

In current VVC specification (v14), there are several constraints on the subpictures: It is a requirement of bitstream conformance that the following constraints apply:
“For any two subpictures subpicA and subpicB, when the index of subpicA is less than the index of subpicB, any coded NAL unit of subPicA shall be located before any coded NAL unit of subPicB in decoding order;
The shapes of the subpictures shall be such that each subpicture, when decoded, shall have its entire left boundary and entire top boundary consisting of picture boundaries or consisting of boundaries of previously decoded subpictures.”

The first constraint is related to the order of the NAL unit in the bitstream. This constraint does not apply to NAL units from different layers and thus in the case of the MLSP layer as the NAL units from a subpicture are referenced from another layer, they do not need to respect this constraint. However, it would be better to remove this constraint.

The second constraint is related to the position of the decoded subpicture in the image. This constraint is necessary in VVC when a subpicture has a spatial dependency with subpictures located at the top or left of the subpicture. This is the case if the image uses a filtering at its border (in loop filtering or deblocking filter).

In the case of the MLSP layer, it is proposed that the subpictures are totally independent: they should have no filter at their border (loop_filter_across_subpic_enabled_flag[i]==0 && subpic_treated_as_pic_flag==1). The constraint on the order of the sub picture should not apply in this case.

The previous embodiments could be applied in a few cases without removing this constraint. (As for example in the case of FIG. 3) but in a new embodiment the constraint on the subpicture shapes is modified in the following way:

“The shapes of the subpictures shall be such that each subpicture which does not have (loop_filter_across_subpic_enabled_flag[i]==0 && subpic_treated_as_pic_flag==1), when decoded, shall have its entire left boundary and entire top boundary consisting of picture boundaries or consisting of boundaries of previously decoded subpictures.”

Relaxing this constraint has several advantages: it is possible to reuse any subpicture from any referenced layer and add subpicture in the MLSP layer. For example, in FIG. 3, without removing the constraint it would be impossible to add the subpicture 4 at high quality in the MLSP layer 0.

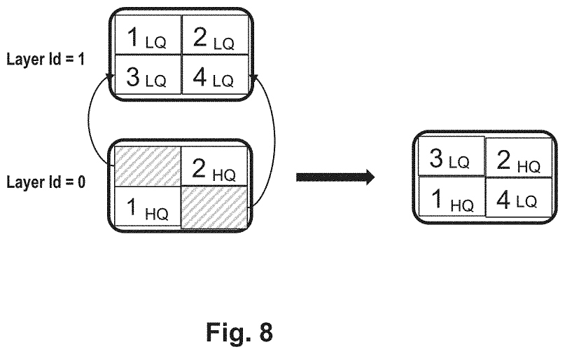

Another advantage is that it is possible to change the position of the referenced subpicture in the MLSP layer. For example, in FIG. 8, the MLSP layer change the positions of the subpictures in its SPS so that it shuffles the location of subpictures compared to their original positions.

A similar constraint exists for the slices in current specification:

“The shapes of the slices of a picture shall be such that each brick, when decoded, shall have its entire left boundary and entire top boundary consisting of a picture boundary or consisting of boundaries of previously decoded brick(s).”

This rule may be replaced by:
The shapes of the slices of a picture shall be such that each brick, when decoded, shall have its entire left boundary and entire top boundary consisting of a picture boundary or subpicture boundary with (loop_filter_across_subpic_enabled_flag[i]==0 && subpic_treated_as_pic_flag==1) or consisting of boundaries of previously decoded brick(s).

The disclosed embodiments can be used in an encoder receiving one or several image streams and encoding a video with several layers: each layer can correspond to one image stream, or to different qualities. This device can be for example a video camera, or a network camera with several sensors for 360° image capture.

Another usage is inside a device which receives several compressed video streams and merge them in a new video stream with several layers. This can be useful for video edition either offline or in real time during the broadcasting of a video.

The embodiments can also be used in a streaming server which receives requests for different videos and can compose the video stream to send to one or several clients.

They may also be used in the client which receives the composed video stream and can decode it or select which version of the video it can decode.

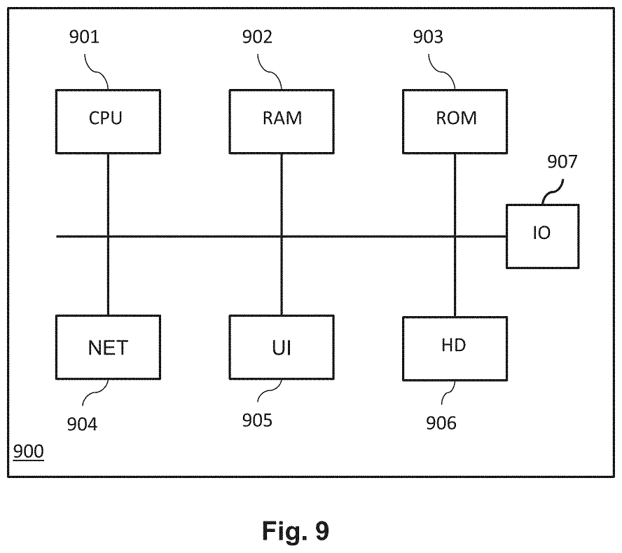

FIG. 9 is a schematic block diagram of a computing device 900 for the implementation of one or more embodiments of the invention. The computing device 900 may be a device such as a microcomputer, a workstation or a light portable device. The computing device 900 comprises a communication bus 902 connected to:
a central processing unit (CPU) 904, such as a microprocessor;
a random access memory (RAM) 908 for storing the executable code of the method of embodiments of the invention as well as the registers adapted to record variables and parameters necessary for implementing the method for encoding pictures, the memory capacity thereof can be expanded by an optional RAM connected to an expansion port, for example;
a read-only memory (ROM) 906 for storing computer programs for implementing embodiments of the invention;
a network interface 912 that is, in turn, typically connected to a communication network 914 over which digital data to be processed are transmitted or received. The network interface 912 can be a single network interface, or composed of a set of different network interfaces (for instance wired and wireless interfaces, or different kinds of wired or wireless interfaces). Data are written to the network interface for transmission or are read from the network interface for reception under the control of the software application running in the CPU 904;
a user interface (UI) 916 for receiving inputs from a user or to display information to a user;
a hard disk (HD) 910;
an VO module 918 for receiving/sending data from/to external devices such as a video source or display.

The executable code may be stored in read only memory 906, on the hard disk 910 or on a removable digital medium for example such as a disk. According to a variant, the executable code of the programs can be received by means of a communication network, via the network interface 912, in order to be stored in one of the storage means of the communication device 900, such as the hard disk 910, before being executed.

The central processing unit 904 is adapted to control and direct the execution of the instructions or portions of software code of the program or programs according to embodiments of the invention, which instructions are stored in one of the aforementioned storage means. After powering on, the CPU 904 is capable of executing instructions from main RAM 908 relating to a software application after those instructions have been loaded from the program ROM 906 or the hard disk (HD) 910, for example. Such a software application, when executed by the CPU 904, causes the steps of the flow charts shown in the previous figures to be performed.

In this embodiment, the apparatus is a programmable apparatus which uses software to implement the invention. However, alternatively, the present invention may be implemented in hardware (for example, in the form of an Application Specific Integrated Circuit or ASIC).

Although the present invention has been described herein above with reference to specific embodiments, the present invention is not limited to the specific embodiments, and modifications will be apparent to a person skilled in the art which lies within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular, the different features from different embodiments may be interchanged or combined, where appropriate.

In the claims, the word “comprising” does not exclude other elements or steps, and the indefinite article “a” or “and” does not exclude a plurality. The mere fact that different features are recited in mutually different dependent claims does not indicate that a combination of these features cannot be advantageously used.

TABLE 1

Descriptor

video_parameter_set_rbsp( ) {

| | |
|---|---|
| vps_video_parameter_set_id | u(4) |
| vps_max_layers_minus1 | u(6) |
| if( vps_max_layers_minus1 > 0 ) | |

| | |
|---|---|
| vps_all_independent_layers_flag | u(1) |

for( i = 0; i <= vps_max_layers_minus1; i++ ) {

| | |
|---|---|
| vps_layer_id[ i ] | u(6) |
| if( i > 0 && !vps_all_independent_layers_flag ) { | |

| | |
|---|---|
| vps_independent_layer_flag[ i ] | u(1) |
| if( !vps_independent_layer_flag[ i ] ) | |

for( j = 0; j < i; j++ )

| | |
|---|---|
| vps_direct_dependency_flag[ i ][ j ] | u(1) |

}

EMBODIMENT 2

if( i > 0 && (vps_all_independent_layers_flag || vps_independent_layer_flag[ i ]

)) {

| | |
|---|---|
| vps_multi_layer_subpicture_flag[ i ] | u(1) |
| if( !vps_multi_layer_subpicture_flag[ i ] ) | |

for( j = 0; j < i; j++ )

| | |
|---|---|
| vps_subpicture_reference_flag[ i ][ j ] | u(1) |

}

EMBODIMENT 1

if( i > 0 && ( vps_all_independent_layers_flag || vps_independent_layer_flag[ i ] ))

{

vps_multi_layer_subpicture_flag[ i ]
if( !vps_multi_layer_subpicture_flag[ i ] )

for( j = i; j < vps_max_layers_minus1; j++ )

vps_subpicture_reference_layerIdX_minus1_flag[ i ][ j ]

}
if( vps_max_layers_minus1 > 0 ) {

| | |
|---|---|
| vps_output_layers_mode | u(2) |
| if( vps_output_layers_mode = = 2 ) | |

for( i = 0; i < vps_max_layers_minus1; i++ )

| | |
|---|---|
| vps_output_layer_flag[ i ] | u(1) |

| | |
|---|---|
| } | |
| vps_constraint_info_present_flag | u(1) |
| vps_reserved_zero_7bits | u(7) |
| if( vps_constraint_info_present_flag ) | |

general_constraint_info( )

| | |
|---|---|
| vps_extension_flag | u(1) |
| if( vps_extension_flag ) | |

while( more_rbsp_data( ) )

| | |
|---|---|
| vps_extension_data_flag | u(1) |

rbsp_trailing_bits( )

}

TABLE 2

Descriptor

seq_parameter_set_rbsp( ) {

| | |
|---|---|
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gdr_enabled_flag | u(1) |
| sps_seq_parameter_set_id | ue(v) |
| chroma_format_idc | ue(v) |
| if( chroma_format_idc = = 3 ) | |

| | |
|---|---|
| separate_colour_plane_flag | u(1) |

| | |
|---|---|
| pic_width_max_in_luma_samples | ue(v) |
| pic_height_max_in_luma_samples | ue(v) |
| subpics_present_flag | u(1) |
| if( subpics_present_flag ) { | |

| | |
|---|---|
| subpics_multi_layer_flag | u(1) |
| max_subpics_minus1 | u(8) |
| subpic_grid_col_width_minus1 | u(v) |
| subpic_grid_row_height_minus1 | u(v) |
| for( i = 0; i < NumSubPicGridRows; i++ ) | |

for( j = 0; j < NumSubPicGridCols; j++ )

| | |
|---|---|
| subpic_grid_idx[ i ][ j ] | u(v) |

for( i = 0; i <= NumSubPics; i++ ) {

| | |
|---|---|
| subpic_treated_as_pic_flag[ i ] | u(1) |
| loop_filter_across_subpic_enabled_flag[ i ] | u(1) |

}

}

TABLE 3

Descriptor

pic_parameter_set_rbsp( ) {

| | |
|---|---|
| pps_pic_parameter_set_id | ue(v) |
| pps_seq_parameter_set_id | ue(v) |
| pic_width_in_luma_samples | ue(v) |
| pic_height_in_luma_samples | ue(v) |
| conformance_window_flag | u(1) |
| if( conformance_window_flag ) { | |

| | |
|---|---|
| conf_win_left_offset | ue(v) |
| conf_win_right_offset | ue(v) |
| conf_win_top_offset | ue(v) |
| conf_win_bottom_offset | ue(v) |

| | |
|---|---|
| } | |
| output_flag_present_flag | u(1) |
| single_tile_in_pic_flag | u(1) |
| if( !single_tile_in_pic_flag ) { | |

| | |
|---|---|
| uniform_tile_spacing_flag | u(1) |
| if( uniform_tile_spacing_flag ) { | |

| | |
|---|---|
| tile_cols_width_minus1 | ue(v) |
| tile_rows_height_minus1 | ue(v) |

} else {

| | |
|---|---|
| num_tile_columns_minus1 | ue(v) |
| num_tile_rows_minus1 | ue(v) |
| for( i = 0; i < num_tile_columns_minus1; i++ ) | |

| | |
|---|---|
| tile_column_width_minus1[ i ] | ue(v) |

for( i = 0; i < num_tile_rows_minus1; i++ )

| | |
|---|---|
| tile_row_height_minus1[ i ] | ue(v) |

| | |
|---|---|
| } | |
| brick_splitting_present_flag | u(1) |
| if( uniform_tile_spacing_flag && brick_splitting_present_flag ) | |

| | |
|---|---|
| num_tiles_in_pic_minus1 | ue(v) |

for( i = 0; brick_splitting_present_flag && i <= num_tiles_in_pic minus1 + 1; i++ ) {

if( RowHeight[ i ] > 1 )

| | |
|---|---|
| brick_split_flag[ i ] | u(1) |

if( brick_split_flag[ i ] ) {

if( RowHeight[ i ] > 2 )

| | |
|---|---|
| uniform_brick_spacing_flag[ i ] | u(1) |

if( uniform_brick_spacing_flag[ i ] )

| | |
|---|---|
| brick_height_minus1[ i ] | ue(v) |

else {

| | |
|---|---|
| num_brick_rows_minus2[ i ] | ue(v) |
| for( j = 0; j <= num_brick_rows_minus2[ i ]; j++ ) | |

| | |
|---|---|
| brick_row_height_minus1[ i ][ j ] | ue(v) |

}

}

| | |
|---|---|
| } | |
| single_brick_per_slice_flag | u(1) |
| if( !single_brick_per_slice_flag ) | |

| | |
|---|---|
| rect_slice_flag | u(1) |

if( rect_slice_flag && !single_brick_per_slice_flag ) {

| | |
|---|---|
| num_slices_in_pic_minus1 | ue(v) |
| bottom_right_brick_idx_length_minus1 | ue(v) |
| for( i = 0; i < num_slices_in_pic_minus1; i++ ) { | |

| | |
|---|---|
| bottom_right_brick_idx_delta[ i ] | u(v) |
| brick_idx_delta_sign_flag[ i ] | u(1) |

}

| | |
|---|---|
| } | |
| loop_filter_across_bricks_enabled_flag | u(1) |
| if( loop_filter_across_bricks_enabled_flag ) | |

| | |
|---|---|
| loop_filter_across_slices_enabled_flag | u(1) |

}

EMBODIMENT 4 (mapping subpic <-> layer_id in PPS)

if( subpics_multi_layer_flag ) {

for( i = 0; i <= NumSubPics; i++ ) {

| | |
|---|---|
| subpic_layer_id_flag[ i ] | u(1) |
| if( subpic_layer_id_flag[ i ] ) | |

| | |
|---|---|
| subpic_layer_id[ i ] | u(6) |

}

}

END EMBODIMENT 4 (mapping subpic <-> layer_id in PPS)

if( rect_slice_flag ) {

| | |
|---|---|
| signalled_slice_id_flag | u(1) |
| if( signalled_slice_id_flag ) { | |

| | |
|---|---|
| signalled_slice_id_length_minus1 | ue(v) |
| for( i = 0; i <= num_slices_in_pic_minus1; i++ ) | |

| | |
|---|---|
| slice_id[ i ] | u(v) |

}

}

....

rbsp_trailing_bits( )

}

TABLE 4

Descriptor

seq_parameter_set_rbsp( ) {

| | |
|---|---|
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gdr_enabled_flag | u(1) |
| sps_seq_parameter_set_id | ue(v) |
| chroma_format_idc | ue(v) |
| if( chroma_format_idc = = 3 ) | |

| | |
|---|---|
| separate_colour_plane_flag | u(1) |

| | |
|---|---|
| pic_width_max_in_luma_samples | ue(v) |
| pic_height_max_in_luma_samples | ue(v) |
| subpics_present_flag | u(1) |
| if( subpics_present_flag ) { | |

| | |
|---|---|
| subpics_multi_layer_flag | u(1) |
| max_subpics_minus1 | u(8) |
| subpic_grid_col_width_minus1 | u(v) |
| subpic_grid_row_height_minus1 | u(v) |
| for( i = 0; i < NumSubPicGridRows; i++ ) | |

for( j = 0; j < NumSubPicGridCols; j++ )

| | |
|---|---|
| subpic_grid_idx[ i ][ j ] | u(v) |

for( i = 0; i <= NumSubPics; i++ ) {

| | |
|---|---|
| subpic_treated_as_pic_flag[ i ] | u(1) |
| loop_filter_across_subpic_enabled_flag[ i ] | u(1) |

EMBODIMENT 5 (mapping subpic <-> layer_id in SPS)

if( subpics_multi_layer_flag) {

| | |
|---|---|
| subpic_layer_id_flag[ i ] | u(1) |
| if( subpic_layer_id_flag[ i ]) | |

| | |
|---|---|
| subpic_layer_id[ i ] | u(6) |

}

END EMBODIMENT 5 (mapping subpic <-> layer_id in SPS)

}

}

TABLE 5

| | Name of | Content of NAL unit and | NAL unit |
|---|---|---|---|
| nal_unit type | nal_unit_type | RBSP syntax structure | type class |
| 0 | TRAIL_NUT | Coded slice of a trailing picture | VCL |
| | | slice_layer_rbsp( ) | |
| 1 | STSA_NUT | Coded slice of an STSA picture | VCL |
| | | slice_layer_rbsp( ) | |
| 2 | RASL_NUT | Coded slice of a RASL picture | VCL |
| | | slice_layer_rbsp( ) | |
| 3 | RADL_NUT | Coded slice of a RADL picture | VCL |
| | | slice_layer_rbsp( ) | |
| 4 | MLSP_NUT | Coded slice of a MLSP picture | VCL |
| | | slice_layer_rbsp( ) | |
| 5 . . . 7 | RSV_VCL_5 . . . | Reserved non-IRAP VCL NAL | VCL |
| | RSV_VCL_7 | unit types | |
| 8 | IDR_W_RADL | Coded slice of an IDR picture | VCL |
| 9 | IDR_N_LP | slice_layer_rbsp( ) | |
| 10 | CRA_NUT | Coded slice of a CRA picture | VCL |
| | | silce_layer_rbsp( ) | |
| 11 | GDR_NUT | Coded slice of a GDR picture | VCL |
| | | slice_layer_rbsp( ) | |
| 12 | RSV_IRAP_VCL12 | Reserved IRAP VCL NAL | VCL |
| 13 | RSV_IRAP_VCL13 | unit types | |
| 14 . . . 15 | RSV_VCL14 . . . | Reserved non-IRAP VCL NAL | VCL |
| | RSV_VCL15 | unit types | |
| 16 | SPS_NUT | Sequence parameter set | non-VCL |
| | | seq_parameter_set_rbsp( ) | |
| 17 | PPS_NUT | Picture parameter set | non-VCL |
| | | pic_parameter_set_rbsp( ) | |
| 18 | APS_NUT | Adaptation parameter set | non-VCL |
| | | adaptation_parameter_set_rbsp( ) | |
| 19 | AUD_NUT | Access unit delimiter | non-VCL |
| | | aceess_unit_delimiter_rbsp( ) | |
| 20 | EOS_NUT | End of sequence | non-VCL |
| | | end_of_seq_rbsp( ) | |
| 21 | EOB-NUT | End of bitstream | non-VCL |
| | | end_of_bitstream_rbsp( ) | |
| 22, 23 | PREFIX_SEI_NUT | Supplemental enhancement | non-VCL |
| | SUFFIX_SEI_NUT | information sei_rbsp( ) | |
| 24 | DPS_NUT | Decoding parameter set | non-VCL |
| | | decoding_parameter_set_rbsp( ) | |
| 25 . . . 27 | RSV_NVCL25 . . . | Reserved non-VCL NAL | non-VCL |
| | RSV_NVCL27 | unit types | |
| 28 . . . 31 | UNSPEC28 . . . | Unspecified non-VCL NAU | non-VCL |
| | UNSPEC31 | unit types | |

TABLE 6

Descriptor

slice_layer_rbsp( ) {

slice_header( )
if (nal_unit_type != MLSP_NUT)

slice_data( )

rbsp_slice_trailing_bits( )

}

TABLE 7

Descriptor

slice_layer_rbsp( ) {

if(nal_unit_type != MLSP_NUT) {

slice_header( )
slice_data( )

} else

| | |
|---|---|
| slice_pic_parameter_set_id | ue(v) |

rbsp_slice_trailing_bits( )

}

1. A method for encoding video data into a bitstream of logical units, the video data comprising pictures, the method comprising:
encoding into the bitstream a first picture belonging to a first layer in the form of a first set of logical units;
encoding into the bitstream a second picture belonging to a second layer different from the first layer, at least a part of the second picture being configured to display at least a first part of the first picture, the encoding of the second picture comprising encoding a first reference between the at least first part of the first picture and at least one logical unit of the first set of logical units.

2. The method according to claim 1, wherein the method further comprises encoding into the bitstream a third picture in the form of a second set of logical units, the third picture belonging to a third layer different from the second layer, and the encoding of the second picture further comprises encoding a second reference between a second part of the second picture and at least one logical unit of the second set of logical units.

3. The method according to claim 1, wherein the method further comprises encoding into the bitstream information associated with the second layer, the information comprising a list of the layers containing logical units referenced by the parts of the second picture.

4. The method according to claim 3, wherein the method further comprises encoding information associated to each layer indicating if each layer comprises or not at least one picture having a part referencing logical units of another layer.

5. The method according to claim 1, wherein the encoded pictures are further grouped into access units, one access unit grouping pictures with a same timing, and wherein the first picture and the second picture belong to the same access unit or to two correlated access units.

6. The method according to claim 1, wherein the encoding of the second picture further comprises encoding a second part of the second picture in the form of logical units belonging to the second layer, the second part being different from the first part.

7. The method according to claim 1, wherein encoding the first reference comprises:
encoding a first sub-reference between the first part and a slice address,
encoding a second sub-reference between the slice address and the at least one logical unit of the first set of logical units.

8. A method for merging at least two bitstreams of logical units of video data, comprising:
assigning at least one merged layer to the logical units of each bitstream;
defining a merging layer;
encoding a merging picture belonging to the merging layer, the merging picture comprising at least, per merged layer, a part of a picture and an associated reference between the subpicture and logical units of the merged layer;
merging into one encoded bitstream the merging picture and the logical units of the merged bitstream.

9. A method for decoding video data from a bitstream of logical units, the video data comprising pictures, the method comprising:
detecting that a first picture of a first layer comprises a part of the first picture, the part of the first picture comprising a reference to logical units of a second picture belonging to a second layer;
selecting the referenced logical units;
decoding the referenced logical units to obtain the part of the first picture.

10. The method according to claim 9, wherein the method comprises beforehand:
analysing a header associated with the first layer;
detecting that the first layer uses logical units from at least a second layer;
filtering logical units to keep logical units associated with the first layer and the at least second layer.

11. (canceled)

12. A non-transitory computer-readable storage medium storing instructions of a computer program for implementing each of the steps of the method according to claim 1.

13. A device comprising a processing unit configured for carrying out each of the steps of the method according to claim 1.

14. (canceled)

15. A media storage device storing a signal carrying encoded video data as a bitstream of logical units, the video data comprising pictures, as resulting from the method according to claim 1.
